(19) United States
(12) Patent Application Publication
(10) Pub. No.: US 2014/0280403 A1
(43) Pub. Date: Sep. 18, 2014

(54) SYSTEM AND METHOD FOR DEVICE-OPTIMIZED TRANSMISSION, RENDERING, EDITING AND STORING OF FILES

(71) Applicant: TotalZero, Inc., Austin, TX (US)

(72) Inventors: Jeff Swansegar, Austin, TX (US); Andy Dewagan, Austin, TX (US)

(73) Assignee: TotalZero, Inc., Austin, TX (US)

(21) Appl. No.: 14/210,143

(22) Filed: Mar. 13, 2014

Related U.S. Application Data
(60) Provisional application No. 61/792,322, filed on Mar. 15, 2013.

(51) Int. Cl. G06F 17/30

(52) U.S. Cl. CPC G06F 17/30076
USPC 707/827

(57) ABSTRACT

The present invention relates to a computer-implemented method and system for device optimized rendering and storage of files to mobile devices. Only the individual parts of a file being accessed by the user are transmitted to the mobile device requiring significantly less bandwidth and time in contrast to downloading a complete file. The file is deconstructed into parts and a data structure is created that associates the individual parts of the file. At least one part of the file is transmitted to the requesting client in a “view only” format. A separate, “editable” format of the same part of the file is transmitted to the client in response to a request to edit the file. When the “editable” part of the file is saved, the updated file part is transmitted to the server and is merged with the master file while retaining the original formatting and the process begins again. A separate “placeholder” format of the same file part is transmitted to the client to represent all file parts that have not been requested on the client and the file parts that has been transmitted to the client.

### BACKGROUND

Present day mobile devices such as mobile phones and tablets are often connected via slow speed connections that do not allow large files to be downloaded in a reasonable amount of time. Mobile devices often do not have enough local memory to hold all files in company data structures. Even if they did, locally storing sensitive files on tablets and mobile phones also has security risks. Just as important, the various file formats and mobile device platforms are mutually proprietary in design and function, thus compatibility issues interfere with files working properly (i.e. rendering properly, allowing local editing, and the like) on mobile devices. These issues can significantly limit the usefulness of the devices for the user. They also cause problems for a company's information technology group trying to support mobile users. They burden Internet providers and cause bandwidth issues due the large amounts of data traversing the Internet network unnecessarily. They cause issues for all parties, corporations, their employees and Internet network providers regarding compliance with the federal regulations around storing personal, financial and healthcare data on computing devices.

Therefore, reducing the data footprint that is necessary for transmission of information, particularly via files, to the mobile device helps to increase mobile usability and reduces wait time associated with accessing and using files, while not locally storing these files in their entirety on mobile devices eliminates or minimizes security risks. The method of temporarily and asynchronously transmitting only parts of large files, which the user may view or edit on any computer or even on a lightweight mobile computing device (meaning a mobile device that is relatively simple, faster or has fewer parts that traditional computing devices such as an ultrabook, tablet, smart phone, mobile phone or the like), and then merges just those individual changes into the full file in a secure, private cloud is needed. This is a critical need that is core to changing, streamlining and speeding computing on mobile devices. Economically, it reduces the needs and costs of the Internet network provider as well as the corporate and consumer end-users.

As mobile device usage continues to increase, there is ever increasing demand on mobile network bandwidth. Workforce productivity, secure data mobility and the ability to utilize multiple types of mobile devices have become priorities for consumers and corporate employees. However, mobile devices are usually proprietary by design, have security risks (devoid of security protocols), ever changing operating platforms, multiple user applications which can increase user support costs. The applications and file formats are similarly proprietary by design. In addition, the mobile workforce demands flexibility, mobile access to company resources as they move away from legacy desktops and laptops while corporate information technology must adhere to certain corporate governance standards and ensure data security.

### SUMMARY

Accordingly, the present system and method provides a computer-implemented system and method that replaces the need to download an entire file with only providing the required part(s) of the file to a mobile or other remotely located device. The file, segmented into parts, is transmitted asynchronously as per the needs of the user, rather than the full download of the file, and then merges the changes to those parts of the file (“file parts” or “pages”) to the master file in the server. This process converts the file temporarily into a non-proprietary device agnostic portable data format that allows the information to be rendered in a non-proprietary format.

Unlike “virtualization” designs, such as “virtual desktop infrastructure” (VDI) or “virtual applications”, the present system and method allows localized processing and rendering of data rather than a “remote control” type of approach where latency and context become significant barriers to usefulness for the user. Thus instead of “remote controlling” a process being accomplished on the back end by a remote desktop or remote application connection, the present system has the file being processed into segments (or parts) on the back end, while the file parts are being individually transmitted on-demand to be used natively with applications installed on the local client device (in parts). These file parts or segments are then reconstructed on a remote, transient server, for example once the user session in terminated.

The present system and method provides for transmitting only the individual parts of the file being accessed by the user, therefore, not requiring significant bandwidth and the time necessary for a full download of the complete file typically to open the file. The file is stored at a primary storage site or in a mail server and is moved to a secure transient storage medium when a request is initiated by the user at a client device to view the file while on a low quality connection. A data structure is then processed within the transient storage that deconstructs the file into parts and then indicates an association to the individual parts of the file. In response to the call made by the client to view the file. A determination is then made to transmit at least one part of the file to the requesting client in a “view only” format. The determined part(s) of the file is transmitted to the respective client. In case the client sends a request to edit the transmitted part of the file, a separate, “editable” format of the same part of the file is then transmitted to the client to replace the “view only” format. When the client sends a request to save the “editable” part of the file, the updated file part is transmitted to the server and is merged with the master file while retaining the original master file formatting. The new, updated master file is then reprocessed as above.

The computer-implemented system and method includes the smart identification and transmission of only the part(s) of the file requested by the user. Parts that are not specifically requested by the user are left untouched in the transient storage server.

The present system addresses the issue of various file formats and mobile device platforms being mutually proprietary in design and function, thus causing compatibility issues that interfere with files working properly (i.e. rendering properly, allowing local editing and the like) on mobile device users. Since each device has a separate, proprietary software foundation and application stack that is normally native only to a particular, limited set of file types, attempting to cross those boundaries results in compatibility issues that affect file rendering and usability. Each third party application may render documents differently, resulting in inconsistency in document handling, often making such files useless. Users attempt to resolve this cross platform compatibility issue by importing these files into third party application tools purchased through device application stores. The present invention addresses this issue directly by providing conversion of files on the server side that allows true portability that cannot be achieved by the device alone or by third party application tools.

### BRIEF DESCRIPTION OF DRAWINGS

These and other features, aspects and advantages of the present invention will become better understood with regard to the following description, appended claims, and accompanying drawings wherein:

FIG. 1 depicts a functional block diagram of the system for the device-optimized transmission, rendering, editing and storing of files.

FIG. 2A depicts an embodiment of a computer system and network suitable for implementing the system for the device-optimized rendering, editing and storing of files.

FIG. 2B depicts an alternate embodiment of a computer system and network suitable for implementing the system for the device-optimized transmission, rendering, editing and storing of files.

FIGS. 3A and 3b are flow diagram of illustrating a high level view of the device optimized transmission, rendering, editing and storing of files function.

FIG. 4 is a block diagram illustrating an embodiment of the device optimized transmission, rendering, editing and storing of files 400.

FIG. 5 illustrates an embodiment of a client server environment of the device optimized transmission, rendering, editing and storage solution.

FIG. 6 illustrates an embodiment of file processing of edited files in the device optimized transmission, rendering, editing and storage solution.

FIG. 7 illustrates an embodiment of the device optimized transmission, rendering, editing and storage solution.

FIG. 8 is a comparison table illustrating the difference between other solutions and the present device optimized rendering, editing and storage solution.

FIG. 9 is an exemplary diagram of the file converter and merger functions of the device optimized transmission, rendering, editing and storage solution.

FIG. 10 is an exemplary diagram of the image file handling function of the device optimized transmission, rendering, editing and storage solution.

FIG. 11 is an exemplary diagram of the file cache, and session manager, file coordinator and client file browser functions of the device optimized transmission, rendering, editing and storage solution.

FIG. 12 is a flow diagram of an exemplary user session at a client device of the device optimized transmission, rendering, editing and storage solution.

FIG. 13 shows exemplary flow diagrams of file handling workflow including file viewing, file editing and file annotation of the present system and solution.

FIG. 14 shows exemplary flow diagrams of the email attachment handling workflow of the present system and solution.

FIG. 15 depicts an embodiment of a computer system suitable for implementing the system for the device-optimized transmission, rendering, editing and storing of files.

FIG. 16 is an exemplary embodiment of a user interface on client device of the present system and solution.

### DETAILED DESCRIPTION OF INVENTION

FIG. 1 depicts a functional block diagram of the system for the device-optimized transmission, rendering, editing and storing of files 100. The system comprises a client device computer such as a mobile phone, laptop or tablet computer 101 having a software client file browser 102, local file cache 103, secure email 104 and document index 105. The client device 101 interfaces with a file handler function 106 located on a computer server at a remote location. The file handler function 106 comprises a session manager function 107, file converter and merger function 108, a file coordinator function 109, email handler function 110, file cache 111, image file handler function 112 and live documents index 110. The file handler function 106 interfaces with an email system 113 and master file directory of documents 114. The functional components of FIG. 1 are described in detail below.

FIG. 2A depicts an embodiment of a computer system and network 200 suitable for implementing the system for the device-optimized transmission, rendering, editing and storing of files. A primary file server computer 205 which includes an operating system for controlling the overall operation of the server 205 and software applications connects to a data storage device 210 and a transient file server computer 215. An email computer server 220 may also be connected to the transient file server computer 215. The transient file server computer 215, the email server computer 220, the data storage device 210 and the primary file server computer 205 may be located beyond a firewall 250 at a physical location such as a corporate headquarters or data center. The transient file server computer 215 communicates through a communication network 225 such as the Internet to a client mobile device 230. The client mobile device 230 communicates through the communication network 225 with software programs residing on the transient file server computer 215. The master file copy 250 is a copy of the master file 245 and is used as a working copy. The client device 230 contains a file application software program 235 for manipulating a type of file the user wishes to access on the client device 230. The client device 230 may also contain email application software 240 for allowing the client device 230 to receive, send, view and manipulate email with file attachments. When the client selects a file to be viewed at the client device 230, the file application program processes the request through the communication network 225 where the transient files server software 215 retrieves the master file 245 through the applicable file server (primary file server 205 or email file server 220). The transient file server computer software 215 determines what part(s) of the master file must be transmitted to the client device 230 and in what type of format (view only or editable).

FIG. 2B depicts an alternate embodiment of a computer system and network suitable for implementing the system for the device-optimized transmission, rendering, editing and storing of files. A primary file server computer 205 which includes an operating system for controlling the overall operation of the server 205 and software applications connects to a data storage device 210 and a transient file server computer 215. An email computer server 220 may also be connected to the transient file server computer 215. The transient file server computer 215, the email server computer 220, the data storage device 210 and the primary file server computer 205 may be located in a cloud infrastructure 255. The transient file server computer 215 communicates through a communication network 225 such as the Internet to a client mobile device 230. The master file copy 250 is a copy of the master file 245 and is used as a working copy. The client mobile device 230 communicates through the communication network 225 with software programs the transient file server computer 215. The client device 230 contains a file application software program 235 for manipulating a type of file the user wishes to access on the client device 230. The client device 230 may also contain email application software 240 for allowing the client device 230 to receive, send, view and manipulate email with file attachments. When the client selects a file to be viewed at the client device 230, the file application program processes the request through the communication network 225 where the transient files server software 215 retrieves the master file 245 through the applicable file server (primary file server 205 or email file server 220). The transient file server computer software 215 determines what part(s) of the master file must be transmitted to the client device 230 and in what type of format (view only or editable).

FIGS. 3A and 3B are flow diagrams illustrating a high level view of the device optimized rendering, editing and storing of files functionality 300. The computer-implemented system and method includes the smart identification and transmission of only the part(s) of a master file requested by the user. Parts of the master file that are not specifically requested by the user are left untouched in the transient storage server. The present system and method works as follows:

When the client selects a file to be viewed at the client device 130 depicted in FIGS. 2A and 2B, the file application 235 or email application 240 program at the client device 230 processes the request through the communication network 225 where the transient files server software 215 retrieves the master file 245 through the applicable file server (primary file server 205 or email file server 220). The transient file server computer software 215 determines what part(s) of the master file must be transmitted to the client device 230 and in what type of format (view only or editable). The transient file server 215 processes the request and retrieves the master file of the file requested by the user from data storage 210 either through the primary file server 215 or the email server 220. The transient file server computer 215 sends a view-only format of the first part of the user-requested file which is then displayed by either the file application 235 or email application 240 on the client device 230. If the user scrolls or otherwise accesses different section of the master file, the client file application 235 or email application 240 determined the part of the file the user wants to view and then requests that information from the transient server 215.

Turning now to FIG. 3A, when the client selects the file it wishes to view at the client device 305, the client file application or email program request is transferred from the client device through a communication network to the transient files server 310. The transient file server determines the master file that is needed to be able to transmit the client requested information to the client device 315. The transient file server requests the master file through a primary file server or an email file server 320. The primary or email file server retrieves the master files from data storage 325. The files that are required (the master files) are stored on a data storage medium in the core infrastructure. The communication between the primary storage and the secure, transient storage is fast and virtually instantaneous. The transient storage server (connected to the transient storage) performs the requested functions.

The transient file server processes the master file into parts and send only a part of the file that the user want to view to the client device 330. When a file is requested, the transient server sends the “view only” format of at least one part (first part) of the requested file and the mobile device (client device) displays this first part and a placeholder is displayed for all remaining parts in the master file that have not been requested.

When the user accesses (usually by scrolling through the file) different sections of the master file (through the aforementioned placeholders), the client determines the part of the file that the user has moved to and then requests that information from the transient server. The transient server processes the requested file and sends the additional requested part in “view only” format to the client. The client device renders the newly transmitted part to replace the previous part. If the user requests to view another part of the file at the client device processing repeats step 330 and processing continues in FIG. 3B.

Turning now to FIG. 3B, if the user selects a file to be edited at the client device, 350 the client file application or email program requests for file is transferred from the client device through a communication network to the transient file server 355. If the user requests to edit any data in the transmitted part(s), an “editable” version of the file part is then transmitted to the client device.

The transient file server sends the editable version of the master file part to the client device 360. If the user updates the editable part 365 and requests to save the changes 375, the edited file part is sent to the transient file server and is merged into the master file in the transient storage while retaining original master file formatting. If the user terminates the session, the updated file in transient storage is then synced with the primary storage medium in the cored infrastructure 380.

If the user does not terminate the session at this point, the session continues in “view only” format by reprocessing the master file on the transient server and reseeding the updated file part to the client to replace the “editable” format being rendered on the client. Placeholders are again used for all remaining file parts. Scrolling and selecting of individual file parts is repeated as above.

If the user searches for a term, the search term is sent to the server which searches the master file and identifies parts where then search term is occurring and sends the “placeholders” to the client. If the user chooses to view a part of the file the process described in [00034] is repeated.

The process is asynchronous and can deconstruct and transmit any part of the file irrespective of their sequence in the file.

Once session is terminated, the secure, transient storage is flushed, and cached file parts on the client device are eliminated. No file data is retained on the client device.

FIG. 4 is a block diagram illustrating an embodiment of the device optimized rendering, editing and storing of files 400. The master files 401 are stored on a primary storage medium 402 within a core infrastructure whether as part of a cloud storage environment or as part of a company unstructured data environment. When the master file is requested, a copy is stored in transient storage 403 such as a transient storage server and the master file is locked in the primary storage to ensure file integrity. The transient storage 403 includes a server that performs the requested functions. The master file 401 is converted to “placeholders” or thumbnails 405, “view only” 406 and “editable” 407 formats and is split into parts. An index 404 is created to enable tracking individual pages of the individual formats to the master the 401. Upon initiation of the session, “placeholders” or thumbnails 405 which have a very low memory footprint are sent to the client and upon request from client for “view only” 406 formats which are lighter in memory footprint than the “editable” formats 407 are transmitted in order to enable faster viewing of the part of the file that has been requested. Upon request from the client to edit the “view only” part, the “editable” 407 version of the part is transmitted and it replaces the “view only” part. Once the session is over, if there are any changes, the master the 401 in the transient storage 403 replaces the version in primary storage 402 and it is unlocked, the copy in the transient storage 403 is destroyed. In case there are no changes to the master file 401, the master file 401 in the transient storage 403 is destroyed and the master file 401 in the primary storage 402 is unlocked.

FIG. 5 illustrates an embodiment of a client server environment of the present system and solution where the master file is split in three formats 500, “placeholders” 504, “view only” 505 and “editable” 507 which are subdivided into parts. The “placeholders” 504 are transmitted to the client 502 from the server 501 when the session is initiated. The “placeholders” 504 give an idea of the individual page structure to the user so that they can make a determination as to which part of the file they want to view.

When the user makes a determination of the part of the file they want to view by scrolling and stopping at that “placeholder part 509, the client 502 sends a request to the server 501 calling for “view only” part 506 to be transmitted. Upon receiving this request the server 501 maps the placeholder” part 509 to the requested “view only” part 506 and transmits it to the client 502. Upon receiving the requested “view only” part 506, the client 502 replaces the “placeholder” part 509 with the “view only” part 506 and displays it to the user.

If the user chooses to edit the “view only” part 506, the client 502 sends a request to the server 501 calling for “editable” part 508 to be transmitted. Upon receiving this request the server 501 maps the “view only” part 509 to the requested “editable” part 506 and transmits it to the client 502. Upon receiving the requested “editable” part 508, the client 502 replaces the “view only” part 506 with the “editable” part 508 and displays it to the user and provides editing controls to the user. If the user saves any of the edits being made, the client 502 transmits the edited “editable” part 508 to the server 501, which maps the “editable” part 508 it has available locally and replaces it with that transmitted from the client 502.

FIG. 6 illustrates an embodiment where a determination is made by the system after the session 600 is ended if there have been any “editable” parts 605 that have been changed by the client. In case there are “editable” part(s) 606 that have been changed, all the “editable” parts 605 are merged to create the master file 604. The transient storage server 602 then sends the updated master file 604 to the primary storage sever 601. When primary storage server 601 receives the updated master file 604, it replaces the original master file 603 with the updated master file 604. In case there are no changes to the “editable” parts 605, then transient storage server 602 sends an update to the primary storage server 601 that the session has ended and master file 603 can be unlocked. Upon receiving this request, the primary storage server 601 unlocks the master file 603.

FIG. 7 illustrates an embodiment 700 where the user searches for a term in the client 702, the search term is sent to the server 701 which searches the index 703 and identifies parts where then search term is occurring and sends those “placeholders” parts to the client 702. If the user chooses to view a part of the file the process is described as follows. When the user makes a determination of the part of the file they want to view by scrolling and stopping at that “placeholder” part 709, the client 702 sends a request to the server 701 calling for “view only” part 706 to be transmitted. Upon receiving this request the server 701 maps the “placeholder” part 709 to the requested “view only” part 706 and transmits it to the client 702. Upon receiving the requested “view only” part 706, the client 702 replaces the “placeholder” part 709 with the “view only” part 706 and displays it to the user.

If the user chooses to edit the “view only” part 706, the client 702 sends a request to the server 701 calling for “editable” part 708 to be transmitted. Upon receiving this request the server 701 maps the “view only” part 709 to the requested “editable” part 706 and transmits it to the client 702. Upon receiving the requested “editable” part 708, the client 702 replaces the “view only” part 706 with the “editable” part 708 and displays it to the user and provides editing controls to the user. If the user saves any of the edits being made, the client 702 transmits the edited “editable” part 708 to the server 701, which maps the “editable” part 708 it has available locally and replaces it with that transmitted from the client 702.

FIG. 8 is a comparison table illustrating the difference between Virtual Desktop Infrastructure (VDI) solutions 801, Cloud Solutions 802 and the present device optimized rendering, editing and storage solution 803. With regard to usability and practicality 804, the VDI solution is designed for use with keyboards and mouse. Therefore it is minimally useful for tablet computers, has negligible use for smartphone devices and also has latency issues 805. Cloud solutions support simple file protocols, are unpredictable with complex text editing files, are good for personal files and for small startup business where security and large scale data structures are not a primary concern, and where cost and simplicity become the primary motivators for the approach 806. The present device optimized rendering, editing and storage solution works for all devices with true format rendering meaning since it is designed for use with corporate files systems 815 and is designed for corporate security 819. The rendering is “true” because it caters consistently to the file format of the original file and is not reliant on the multitude of individual software editors and devices being sold by numerous vendors today. With regard to deployment and investment 808, VDI solutions have high upfront costs due to infrastructure requirements, system licensing, application licensing, maintenance and investment in purchasing user devices 809. Cloud solutions have medium upfront costs because of the need to copy or migrate data to the cloud, data duplication costs, data sprawl (meaning data that is located in mange storage mediums, device and even data centers and may be duplicated and have multiple versions) and device application costs 810. The present device optimized rendering, editing and storage solution integrates into the current infrastructure, is a plug and play application, has active directory integration and no additional software besides the current software on the mobile device and the software for the present device optimized rendering, editing and storage solution 811. With regard to user applications 812, VDI solutions include applications designed for keyboard and mouse, not touchscreen tablets and mobile phones 813. Cloud solutions require that the user must download non-standard applications from application stores which present the risk of the corruption files and the introduction of various integrity issues such as viruses 814. The present device optimized rendering, editing and storage solution integrates file viewers and editors, handles files and email attachments with no additional software required 815, 811. With regard to security and governance 816, VDI solutions are highly secure if connected through a secure VPN tunnel 817. Cloud solutions have security and compliance risks because they use shared computer space (storage and computing resources) and also have authentication and authorization management issues 818. The present device optimized rendering, editing and storage solution is highly secure since it is on demand, secure with a session based tunnel that leaves no trail 819, for example no residual data. With regard to internet network bandwidth requirements 820, VDI solutions are affected by latency and network quality with high network bandwidth requirements because all files are viewed and edited remotely 821. Cloud solutions require that whatever is not already loaded locally be downloaded so there can be long waits and high bandwidth usage 822. The present device optimized rendering, editing and storage solution does not require a download of full file formats, requires no additional software applications and integrates across mobile devices and platforms 823.

FIG. 9 is an exemplary diagram of the file converter and merger functions of the device optimized transmission, rendering, editing and storage solution 900. When a user requests to view or edit a file at a the client device, the associated master file (FIG. 1 114, and FIGS. 2A and 2B, 245) is retrieved from data storage (FIGS. 2A and 2B, 210) by a transient file server (FIGS. 2A and 2B, s15) through either a primary files server (FIGS. 2A and 2B, 205) or an email file server (FIGS. 2A and 2B 220). Security rights associated with the user are verified. Turning now to FIG. 9, the cached original document or master file 901 is copied from the master file to a local appliance file system. All individual file parts and changes are tracked at the client device via a live document index 902 that is created by the file converter and merger functions 900. Each time changes (to a file part) are accepted, they are merged with the original file, and the file is then reconverted based on file type, refreshing the session at the client device. Closing the document at the client device flushes the local cache and the resulting document/file changes are merged with the master file document as described in the processing for FIG. 3. In the embodiment shown in FIG. 9, three example types of files (however many types of other file types are supported) that may be requested to be viewed and/or edited at the client device are shown: portable network graphic (“PNG’) or similar small pictorial 906 format files, portable document format (“PDF”) files 905 and open Office XML (“OOXML” or “XML”) files 904. When the client requests to view or edit a file, the live document index 902 maps the individual file parts or pages of the applicable format of the three individual formats to the original document. Annotations and changes made during editing and annotation session on the client are tracked and merged to the original document in real-time. The live document index 902 is shared with the client for real-time updates triggered by actions on the client and subsequent processing action on the server. Following a file merge with the master file, the live document index 902 is refreshed or recreated as required to maintain the current status on both the client device and the master file. At the client device, if the user views a file such as a PNG file type 906 it is by clicking through individual file parts. The live document index 902 indexes to the individual file parts for both edit and view-only formats for client interaction purposes. At the client device, if the user views or wishes to edit a view-only” file part such as a PDF file type 905, the live document index 902 is updated and file parts are sent as individual parts that are locally reconstructed as pages for viewing. If the user wants to annotate the PDF document a cached annotated PDF file 903 is created. Annotations do not affect the master original file since this file is only changed through the edit function using the XML pages. Edits are made to individual file parts, not to the master file until changes have been accepted at the end of editing sessions. (In each example above, and in subsequent examples, various other file types with similar properties may be substituted to provide similar results in this system and methodology.)

Annotations are limited to the view only file parts such as a PDF version of the files and merged into a single annotated PDF, though other file types may be used. Annotation changes are made to the individual pages and sent to the live document index 902 for merging. Introduction of annotations (edits) require a master annotated PDF file. Annotation of a PDF file means highlights, call outs, pinned notes, grading and the like. At the client device, if the user views or wishes to edit an XML file type 904, the live document index 902 is created and the file part is sent as individual pages. When the user wants to edit the XML document, pages are sent to the client one at a time but include the requested page, the previous page and the next page. Edits that are made by the user at the client device are sent to the live document index 902 for merging with the master file.

FIG. 10 is an exemplary diagram of the image file handling function of the device optimized transmission, rendering, editing and storage solution 1000. For files that are an image type such as a TIFF formatted file 1001, when a user want to view or edit the file, the original image (master file) is retrieved from data storage based on security rights associated with a user. Multi-image or multi-page files are split into individual images in a file cache. Options for determining the image quality (resolution of the display) are available in the configuration tools to allow for fine text scan, medical images and other types of images. Lower quality resolution displays allow for quicker viewing. The image file handler 1000 uses these selectable configuration options and the device screen type to process the image appropriately. In an exemplary embodiment, a TIFF image file 1001 is copied from the master file system to a local appliance cache and then converted. All individual images are split into individual files within the cache where multi-image files reside. The live image index 1002 maps the thumbnail of the PNG or similar small pictorial format file 1003 to the individual image files. The user at the client device scrolls through the thumbnails to display individual images as desires. The live image index 1002 is used by a session manager within the transient file server to transmit the appropriate image to the client. The live image index 1002 allows individual PDF files 1004 to be transferred to the client device as individual images (file parts) for viewing and annotation purposes. Annotation changes are made to individual pages and sent to the live image index 1002 for merging. Annotations require a master annotated View Only file such as a PDF file be created on the transient or primary file server and it is saved in the same directory as the master file. Annotation changes are made to the individual pages and sent to the live image index 1002 for merging. Introduction of annotations (edits) require a master annotated PDF file and a cached annotated PDF file 1005. Annotation of a PDF file means highlights, call outs, pinned notes, grading and the like. In addition, annotations may be applied much like a transparency on top of a file. When the annotations are complete, the transparency is merged with the underlying file and a new file is created leaving the master unchanged. (In each example above, and in subsequent examples, various other file types with similar properties may be substituted to provide similar results in this system and methodology.)

FIG. 11 is an exemplary diagram of the file cache, and session manager, file coordinator and client file browser functions of the device optimized transmission, rendering, editing and storage solution 1100. The session manager 1116 is a service on the server that utilizes current state, monitors network connections, maintains the document or image index and calls the file merger and converter file function (FIG. 9) as needed. The session manager 1116, located on a computer server remotely from the client device 1103 uses the file coordinator (FIG. 12) at the beginning and end of a session to make changes to the master file 1104 or in the case of View Only files such as PDF documents, an annotated file 1110. The master file documents 1104 are either located on a computer server or data storage device accessible to the computer server. Changes are tracked against the live document index of the original document 1101 utilizing cached file parts 1102 with copies 1105, 1106, 1107 and 1108 of the original master file 1104 documents 1109, 1110 that are created and refreshed to maintain the current state of the file at the client device 1103 as a user views, edits or otherwise manipulates the file at the client device 1103. The cached file parts 1102 are merged with the master file 1104 only at the end of the session at the client device 1103. Therefore, the master file documents 1104 are not changed unless the user ends the session at the client device 1103 or opts to merge any changes made in the files 1105, 1106, 1107, 1108 at the client device 1103. The user can also choose to have a new file created rather than merge the changes with the original master file documents 1104. Annotation to client View Only files such as PDFs 1108 force the creation of a new annotated PDF 1111 in the master file 1104 at the end of a session at the client device 1103. The annotated PDF file 1111 may default to the same master file 1104 directory or location as the non-annotated PDF file 1110 and the user is prompted at the client device 1103 to name the annotated PDF file 1111 or the rename the non-annotated PDF file 1110. When the changes or annotations are merged, the merged/annotated files 1109, 1111 in the master file documents 1104 maintain the same file format and extension as the original files 1109, 1111 unless the user at the client device 1103 opts to change the file type or name. At the client device 1103, files are allowed to be displayed, edited and annotated based on user commands at the client device 1103. A temporary local cache that may be encrypted is created for file interaction locally. The index 1112 at the client device 1103 is shared between the cached file parts 1102 and the file parts being displayed 1113 at the client device to maintain the integrity of the file session. The session manager function 1100 is initiated when a user accesses a file that is a master file document 1104. The session manager function is terminated when the user closes the file at the client device 1103 or otherwise terminates the session (device is powered off, another function is accessed or the like). Changes made to the file part 1113 at the client device 1103 are tracked by the indexes 1112, 1101 so the changes are available to the client in real-time. The file parts at the client device 1113 and any caches are flushed (deleted) at the end of each session. The file coordinator 1200 acts as a user security and file movement tool that interacts with a company's file system and security controls. It enables copying, caching, merging and creating of documents on company file system in the master file and the file cache and session manager. It also provides file browsing and drive mapping capabilities which are viewable through a client file browser. File part data structure is viewed and controlled by the user on the client device through the client file browser. A client file part browser 1117 at the client device (FIG. 11, 1103) allows a user to access files/document in a master file system 1104 and view and otherwise manipulate copies of those files at the client device. The session manager 1116 is responsible for all interaction with the client. The file coordinator 1115 provides the interface with the master file documents 1104 that are located on a computer server or data storage device and the file coordinator 1115 is responsible for all movement of the file with back end systems. It enables the copying, caching, merging and creating of documents and cached files. The session manager provides file browsing and drive mapping capabilities that allow a user at a client device 1103 to access available files.

FIG. 12 is a flow diagram of an exemplary session 1200 by a user at a client device that accesses documents in a remotely located master file of documents. A session is initiated 1201 when at a client device, a user selects a document (file) that is located in a remotely located master file of documents 1202. The session handler and file coordinator are initiated 1203. The file coordinator sends the necessary user security token to master file system for rights to open file 1204. The file coordinator copies file from file system to a gateway (for example the transient file server 115 of FIG. 1) and hands off to file converter 1205. File conversion begins 1206. The file converter caches original file and converts it to the XML based file structure depicted in FIG. 4. based on the file type, for example to either a thumbnail strip (control strip), a multi-page view only file such as a PDF (view or annotate) or an XML based file (edit) 1207. The file converter creates a corresponding document index mapping file parts to renderable pages necessary for client rendering 1208. The gateway maintains all file parts in local cache for instantaneous, individual transmission to client 1209. Transmission of the file parts now begins 1210. The gateway sends necessary file parts such as control strips and view only pdf files to client to open in view mode 1211. The client, copies index into memory and constructs locally to render both a thumbnail strip and a document page in view mode 1212. The session manager on the gateway receives calls from client for individual file parts and transmits 1213. The session manager receives any user supplied changes and sends to file merger for processing with original file at session close 1214. The updated file is sent back to file converter to update cache with new file parts that contain the processed updates (creating a single loop) 1215. The session handling function 1216 on a computer server manages current navigation state, monitors network connection, maintains the document index and interacts with the file merger and file convertor as necessary. The client manages user session both viewing and editing capabilities 1217. The client caches individual file parts and edits and sends updates to gateway 1218. The client maintains single file part updating only and closes individual edit session and commits changes in each file part before allowing a new file part to start new edit session 1219. The gateway commits changes and merges into original file or creates new files as necessary 1220. The client manages print and fax requests to local resources and/or remote office resources 1221.

FIG. 13 shows exemplary flow diagrams of file handling workflow including file viewing, file editing and file annotation 1300. In the file view function 1324, a user initiates a file at the client file browser 1301. The file coordinator retrieves the file and copies to cache in the file handler function 1302. The file converter converts the file to an XML based “file part” structure and creates a document index 1303. The session manager maintains the live index and file parts and synchronized between the client and the session 1304. When the user views and then closes file at the client device, the local cache is flushed 1305. The session manager flushes the cache and hands off the session to the file coordinator for more file browsing 1306.

In the file edit function 1325, if the user accesses a file at the file browser 1307, the file coordinator retrieves the file and copies it to the cache at the file handler 1308. The file converter and merger function converts the file to an XML based “file part” structure and creates a document index 1309. The session manager maintains the document index and file parts current between the client and the file handler 1310. If the user edits and then closes the document at the client device, the client file part browser function presents the user with save options 1311. The session manager hands the file off to the file merger function for merging processing 1312. The session manager hands the file off to the file coordinator for the save process or an attachment controller for email options 1313. Upon termination of the session, the session manager flushes the file cache and terminates the file session 1314.

In the file annotation function 1326, if the user accesses a file at the file browser 1315, the file coordinator retrieves the file and copies it to the cache at the file handler 1316. The file converter splits the file based on file type and creates a document index 1317. The session manager maintains the document index and pages current between the client and the image file handler 1318. If the user annotates the file (this is usually a file in “view only” mode) at the client device and then closes the file, the client file browser function presents the user with save options 1319. The session manager hands the file off to the file merger function for merging processing 1320. The session manager hand the file off to the file coordinator for the save the new annotated file to the master file 1321. The merger function hands the file off to the file coordinator for the save process or an attachment controller for email options 1322. Upon termination of the session, the session manager flushes the file cache and terminates the file session 1323.

FIG. 14 shows exemplary flow diagrams of the email attachment handling workflow 1400. A secure email function intercepts email attachments only, and allows all other email related traffic to pass between the client device and the server. When an attachment link at the client device is selected, the secure email client intercepts the attachment request and routes it to the file handler located on the server. The email that is downloaded to the client device then does not contain the file attachments, simply file location pointers that communicate with the file handler on the server. Processing, viewing and editing of the email attachments are then handled according to file type in accordance with the processing described in FIGS. 9, 10, 11 and 12. For the reply with edited attachment 1409, if an email attachment is accessed by the user at the client device 1401, the attachment is intercepted by the email attachment hander 1402. If the user updates the email attachment during the file view or edit session 1403, then when the user terminates the session, the file remains in the handler cache 1404. The user is presented with the normal email command options such as reply, “save as” for attachments and the like 1405. If the user replies with an attachment, the email client opens the reply email 1406 and the client attaches a file placeholder in the email body 1407.

For the save email attachment to file system 1410, if an email attachment is accessed by the user at the client device 1411, the attachment is intercepted by the email attachment hander 1412. If the user updates the email attachment during the file view or edit session 1413, then when the user terminates the session, the file remains in the handler cache 1414. The user is presented with the normal email command options such as reply, “save as” for attachments and the like 1415. If the user replies chooses “save as”, the user at the client device is presented with the file save options 1416. The file is then sent to the file coordinator and the saving of the email attachments is then handled according to file type in accordance with the processing described in FIGS. 9, 10, 11 and 12 1417.

FIG. 15 depicts an embodiment of a computer system 1500 suitable for implementing the system for the device-optimized rendering, editing and storing of files. A gateway server 1504 houses the file handler, and consists of the functions associated with the file converter, file merger, file cache, file index, file sessions manager, file coordinator, offline file manager and file security software functions (component names chosen for this depiction are for the purpose of representing specific functions). The gateway server may be a special purpose computer such as a computer server adapted for gateway processing. The software on the gateway server 1504 connects to an email system processor and a master file system that includes or has access to master the data storage. The file client 1501 located at the client device includes the client browser, local file sync, secure email client, application interfaces, a file viewer and editor. The file client at the client device 1501 may be connected either through a communication network or secure VPN type connection 1502 to the gateway server 1504. The gateway server may also be located behind a firewall 1503 to ensure security. The gateway server communicates with an email system 1506 and a master file system 1505 that includes or has access to the data storage for the master file of documents.

FIG. 16 is an exemplary embodiment of a user interface on client device 1600. A scrollable and clickable thumbnail control panel 1601 serves a reference point for the user to navigate through and access individual file/document pages. Note that thumbnails and placeholders are synonymous throughout this specification. It translates accesses to the document index for page mapping to XML based file parts. It displays a thumbnail display of the corresponding document pages. It allows switching between editing and viewing modes. The file panel display 1602 displays the document, scrolls one page at a time and triggers additional pages to be displayed. It allows zoom and text sections and copy functions along with basic print and fax functions. Depending on the type of document, cut and paste needs or edit functions are available by using the editing tool bar 1603 that is available at the top of the display 1604.

Although the present invention has been described in detail with reference to certain preferred embodiments, it should be apparent that modifications and adaptations to those embodiments might occur to persons skilled in the art without departing from the spirit and scope of the present invention.

1. A computer system for device optimized rendering of files on a mobile device comprising:
a. a processor;
b. a memory coupled to the processor;
c. a mobile device;
d. wherein the memory stores a computer program that, when executed by the processor causes the processor to:
i. input a master file from data storage into computer memory, said master file corresponds to a file request on the mobile device by a mobile device user wherein the file request is transferred from the mobile device through a communication network to a session manager computer application on a file server computer located remotely from the mobile device;
ii. execute a file converter and merger function that segments the master file into optimized file parts having a device agnostic data format that optimizes the rendering of the file on the mobile device;
iii. determine the optimized file part that corresponds to the file section requested by the mobile device user;
iv. cause the optimized file part to be sent to the mobile device; and
v. repeat the processing in (i) through (iv) in response to the mobile device user requests to open another file part of the master file at the mobile device.

2. The system of claim 1, further comprising in response to a terminate request received from the mobile device when the mobile device user closes the optimized file part and if the user edits the optimized file part, use the edited optimized file part to reconstruct the master file in the master file's original data format with the user edits.

3. The system of claim 1 wherein the optimized file part sent to the mobile device is a view-only file part.

4. The system of claim 1 wherein the optimized file part sent to the mobile device is an editable file part.

5. The system of claim 3 further comprising executing a computer program that when executed by the processor causes the optimized file part to be represented as a file part selected from the group consisting of a placeholder, a view-only file part and an editable file part.

6. The system of claim 5 further comprising executing a computer program that when executed by the processor causes the processor to replace the view-only file part with an editable file part in response to a user request to edit the file at the mobile device.

7. The system of claim 6 further comprising executing a computer program that when executed by the processor causes the processor to send the view-only file part of the requested file to the mobile device and send the placeholder file part for all remaining parts of the file corresponding to the master file that have not been requested at the mobile device.

8. The system of claim 1 wherein the file requested by the mobile device user is selected from the group consisting of an email attachment, a file attachment and a linked file.

9. The system of claim 1 wherein the file optimization and sending is asynchronous wherein the file is optimized into file parts and transmitted to the mobile device irrespective of the location of the file part in the master file.

10. The system of claim 1 further comprising determining a placeholder file part for parts of the file included in the master file that are not required to be currently displayed on the mobile device.

11. The system of claim 10, wherein a view-only file part is sent to the mobile device to replace the placeholder file part if the mobile device user requests to view the part of the file represented by the placeholder file part.

12. The system of claim 1 further comprising in response to a file request to edit the file part at the mobile device:
a. a transient file server sends an editable version of the file part having the non-proprietary device agnostic data format to the mobile device;
b. the user edits the file part on the mobile device;
c. the steps a and b are repeated in response to requests from the user to edit one or more file parts; and
d. in response to the user ending the editing of file parts on the mobile device, the transient file server syncs the edited file part with the master file and stores an edited master file in data storage.

13. A computer-Implemented method for device optimized rendering of files to a mobile device, the method implemented by computer-executable instructions being executed by a computer processor comprising the steps of:
a. inputting a master file from data storage into computer memory, said master file corresponding to a file request on the mobile device by a mobile device user wherein the file request is transferred from the mobile device through a communication network to a session manager computer application on a file server computer located remotely from the mobile device;
b. executing a file converter and merger function that segments the master file into optimized file parts having a device agnostic data format that optimizes the rendering of the file on the mobile device;
c. determining the optimized file part that corresponds to the file requested by the mobile device user;
d. causing the optimized file part to be sent to the mobile device; and
e. repeating the processing in (i) through (iv) in response to the mobile device user requests to open another file part of the master file at the mobile device.

14. The method of claim 13, further comprising in response to a terminate request received from the mobile device when the mobile device user closes the optimized file part and if the user edits the optimized file part, using the edited optimized file part to reconstruct the master file in the master filers original data format with the user edits.

15. The method of claim 13 wherein the optimized file part sent to the mobile device is a view-only file part.

16. The method of claim 13 wherein the optimized file part sent to the mobile device is an editable file part.

17. The method of claim 15 further comprising the step of optimizing the file part to be represented as a file part selected from the group consisting of a placeholder, a view-only file part and an editable file part.

18. The method of claim 17 further comprising the step of replacing the view-only file part with an editable file part in response to a user request to edit the file at the mobile device.

19. The method of claim 18 further comprising the step of sending the view-only file part of the requested file to the mobile device and sending the placeholder file part for all remaining parts of the file corresponding to the master file that have not been requested at the mobile device.

20. The method of claim 13 wherein the file requested by the mobile device user is selected from the group consisting of an email attachment, a file attachment and a linked file.

21. The method of claim 13 wherein the file optimization and sending is asynchronous wherein the file is optimized into file parts and transmitted to the mobile device irrespective of the location of the file part in the master file.

22. The method of claim 13 further comprising the step of determining a placeholder file part for parts of the file that are not required to be currently displayed on the mobile device.

23. The method of claim 22 wherein a view-only file part is sent to the mobile device to replace the placeholder file part if the mobile device user requests to view the part of the file included in the master file represented by the placeholder file part.

24. The method of claim 13 further comprising the steps of:
a. causing a transient file server to send an editable version of the file part having the non-proprietary device agnostic data format to the mobile device;
b. repeating step (a) in response to requests from the user to edit one or more file parts; and
c. in response to the user ending the editing of file parts on the mobile device, causing the transient file server to sync the edited file part with the master file and storing an edited master file in data storage.
